(19) United States
(12) Patent Application Publication
(10) Pub. No.: US 2008/0189976 A1
(43) Pub. Date: Aug. 14, 2008

(54) Process and appliance for drying byproducts

(76) Inventors: Lothar Krell, Erkerode (DE); Gerald Caspers, Meine (DE); Christian Klein, Wolfenbuttel (DE)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/748,089

(22) Filed: May 14, 2007

(30) Foreign Application Priority Data
Feb. 9, 2007 (EP) 07002862.6

(51) Int. Cl. F26B 17/00; F26B 25/00

(52) U.S. Cl. 34/359; 34/586

(57) ABSTRACT

This invention relates to a process and an appliance for drying byproducts from the processing of starch-containing and sugar-containing raw materials, in particular, after their fermentation and distillation, where the byproduct is fractionated in a purification phase with a high liquid proportion and a thick phase, whereby the thick phase is shaped into particles in a conditioning procedure and whereby these particles are dried in a fluidized-bed drying system with a relative gap volume, in the fluidized-bed layer, between 0.5 and 0.92.

### BACKGROUND OF THE INVENTION

1. Field of the Invention

This invention relates to a process and an appliance for drying byproducts that accrue during the processing of starch-containing and sugar-containing raw materials, especially after a fermentation or distillation.

2. Description of the Related Art

During the processing of starch-containing and sugar-containing raw materials, for example, during the production of alcohol or beer, raw materials are preferably ground and are fermented by adding water and yeast. The resultant alcohol is taken out and the remaining byproducts are used in some fashion. At typical byproduct is the so-called malt residuum that, in addition to the carbohydrates, contains substances that are supplied to the mash, for example, albumin, fats and mineral substances as well as other constituents of grain. The malt residuum precipitates with a relatively large fluid proportion so that it can be used, fluid, as fertilizer or, dried, as fodder material. The dried malt residuum of grain mashes is also called DDGS (Distillers Dried Grains with Solubles). Various processes have been proposed to make the DDGS; on the basis of mechanical or thermal stresses, these processes destroy the constituents and alter high-grade fodder in a disadvantageous manner. Likewise, the proposed drying methods are sometimes expensive, for example, in the case of freeze-drying, as proposed, something that requires the use of large volumes of energy.

A process to make animal fodder from malt residuum is described in WO 83/00007 A1, where the fluid stream from a fermenter, via a centrifuge, is separated into a yeast-rich and into an essentially yeast-free product stream. Prior to separation, the solid material is separated via a sieve device and is supplied to a separator. The separator is heated via indirect steam supply. The malt residuum is continually evacuated from the separator and is supplied to a granulation drum. Dried particles, that are returned [recycled] to a drying unit, are also returned to that drum. An air flow is conducted through the granulation drum.

DE 102 49 027 A1 describes a system for making alcohol where the malt residuum is fractionated via a decanter to a thin juice and into a so-called “wet cake.” The thin juice is thickened to form a thick juice or syrup and is mixed with wet-cake. Scale parts are added to the mixture and are passed on to a drying station for final drying. The dryer can be made in the form of a hot-steam dryer.

A similar system and a similar process are described in U.S. Pat. No. 3,925,904, where, after mechanical drainage via presses or centrifuges, a liquid phase is inspissated and is again recycled into the “wet cake.” This mixture or dispersion is supplied to a flash-drying process with a relatively high moisture content of more than 60%. Instead of a press or centrifuge, U.S. Pat. No. 5,958,233 describes a similar process with a decanter.

### SUMMARY OF THE INVENTION

Starting with this state of the art, the object of the invention is to provide a process and an appliance for drying byproducts that accrue during the processing of starch-containing and sugar-containing raw materials, which will facilitate gentle drying and processing of the byproduct into a dust-poor, pourable and mechanically stable product. This problem is solved according to the invention by a process with the features of Claim 1 and an appliance with the features of Claim 12. Advantageous embodiments and developments of the invention are given in the subclaims.

The invention-based process for drying byproducts, that are obtained during the processing of starch-containing and sugar-containing raw materials, especially, after fermentation and distillation, where the byproduct is fractionated in a purification phase with a high-liquid proportion and into a thick phase, provides that the separated thick phase be formed into particles in a conditioning procedure and that these particles are dried in a fluidized-bed drying unit with a relative gap volume in the range of between 0.5 and 0.92.

It was found quite by surprise that the malt residuum, which is conditioned and is formed into particles, can be dried effectively and without decomposing in a fluidized-bed procedure with a relatively high gap volume in the fluidized-bed, so that one can get an unproblematically further processed product of good quality. The particles can be dried gently in the fluidized-bed drying unit and with a high degree of efficiency so that, as end product, one gets the bulk material that is essentially dust-free and that, in terms of its moisture content, can be adapted to the requirements of the customers of the dried byproduct.

To ensure the most energy-saving fractionation of the output byproduct, there is provided a gravitational fractionation, in which the byproduct, for example, in the form of a malt residuum, is supplied to a simple or multiple gravitational field, so that there takes place a separation into a thick phase and a purification phase. A simple gravitational field, for example, is provided via a curved sieve, while a decanter or a centrifuge will provide a multiple gravitational field and will deliver the thick phase with a higher solid proportion.

A development of the process provides the following: the purification phase is evaporated into a syrup and the syrup is supplied to the thick phase, so that one gets a mixed phase. The resultant mixed phase—that was enriched by the constituents of the purification phase—is then conditioned like the thick phase and is dried or further processed. The mixed phase is a modified thick phase to which one can add not only syrup but also other substances. The statements concerning the thick phase also apply to the mixed phase and vice versa.

Drying in the fluidized-bed drying unit can also result in a heating of the particles so that, subsequently, there must be a cooling of the dried particles or of the dry product. This cooling preferably takes place in a fluidized-bed apparatus which facilitates both effective cooling and gentle transport of the dried particles.

Preferably, the dry substance contents of the thick or mixed phase is adjusted, prior to conditioning, within a range of between 30% and 60%, preferably a range of about 40%, before the thick or mixed phase is conditioned in a shaping procedure. It was found quite by surprise that the thick or mixed phase, with this comparatively low dry substance content, can—by means of the conditioning procedure—be shaped into an adequately mechanically stable form with which one can then perform a subsequent fluidization and drying into a uniform, granular product in the fluidized-bed drying unit.

The conditioning of the thick or mixed phase can take place in an expander, an extruder, or pelletizer, possibly these units can be combined with each other. Such conditioning appliances are usually employed only for the processing of products with a higher dry substance content, so that for the most part one would be quite surprised that relatively low dry substance contents in the thick and mixed phase can be shaped into particles by means of these conditioning appliances. While conditioning the thick and mixed phase, one can adjust the mechanical strength with the action of pressure and temperature, by the same token, a chemical-physical change can be brought about due to conditioning, which change can influence the dried end product.

The conditioning here takes place to the extent that fluidizable individual particles are present. The dried end product is dust-poor and has very good pourability. That results in good handling of the manufactured product in connection with all logistical processes.

One can use, as drying fluid, superheated water vapor in the fluidized-bed drying unit, which vapor is preferably conducted in the cycle. The drying fluid can be superheated outside the fluidized-bed layer by means of hot steam. The water that is evaporated from the conditioned particles can be used as drying vapors for energy utilization due to the release of the contained condensation enthalpy in a technological step of the process as a whole. As a result, one can considerably reduce the energy expenditure connected with the processing of starch-containing and sugar-containing raw materials.

Drying conditions can be adjusted within the fluidized-bed drying unit to treat the product gently; in combination with an almost oxygen-poor water vapor atmosphere, there are only slight product losses due to the greatly restricted oxidation of the drying material.

Because the dried particles are practically not hornified, the dried product displays good rehydratizability. Depending on the need, for example, to feed animals, the dried particles can be provided with a higher moisture content. The good hornified product permits a good resorption of the nutrients, so that the end product has a high physiological quality.

Additives can be added to the thick and mixed phase in order to influence the properties of the end product or also the thick and mixed phase. To be able to adjust the moisture content of the thick and mixed phase, one can add an additive with a moisture content that is less than the moisture content of thick phase. Possibly, fluid might have to be added when the thick and mixed phase does not have the required consistency for conditioning in the corresponding appliance. If the end product is to contain fluid and nutrients, which are not present or not adequately present in the byproduct, said nutrients can also be added.

A development provides the following: a part of the dried particles is returned as additive to the thick phase and to the syrup. The return [recycling] of the already dried particles facilitates the adjustment of the thick and mixed phase at a degree of drying or at a dry substance content that facilitates the conditioning—essentially with stable form—of the thick and mixed phase into particles. The dried particles can be added to the thick and mixed phase as additives, alone, or with additional additives.

The invention-based appliance for drying byproducts which accrue during the processing of starch-containing and sugar-containing raw materials, especially those that are obtained from fermentation and distillation, provides the following: there is a mechanical separation device for separation into a purification phase, with a high liquid proportion, and a thick phase. Series-connected after the separation device is a shaping conditioning device that shapes, into particles, the thick phase or a mixed phase from the purification phase and the thick phase and possible additives, whereby a fluidized-bed drying unit is series-connected after the conditioning device, in which unit the particles are dried. The fluidized-bed drying unit works with a relative gap volume, in the fluidized-bed layer, of between 0.5 and 0.92, and fluidizes the particles that are to be dried, which results in gentle drying.

If the thick phase must or should be enriched or modified, one can also provide an evaporator for the purification phase to make a syrup, as well as a feeder unit for the evaporated purification phase into the thick phase, for example, in a mixing device.

A cooling device, especially a fluidized-bed apparatus, is series-connected after the drying unit in order to obtain a cooled, transportable and pourable product.

The separation device for fractioning the byproduct, for example, the malt residuum from a distillation process, can be made as a simple or multiple gravitational field, by the same token, one can also provide alternate separation devices or appliances, in order to perform a separation into a rather liquid purification phase and into a thick phase. For example, one can use decanters or centrifuges as devices for the generation of a multiple gravitational field; an arched sieve is an example of a simple gravitational field.

As conditioning device for the thick and mixed phase, one can use expanders, extruders, or pelletizers; one can also use several such conditioning devices in combination in order to get the desired particle shape or particle size.

As a development of the invention, a return [recycling] device transports a partial stream of the dried particles to the mixing device so, that in that way, the desired dried substance content can be set in the thick and mixed phase prior to being moved on to the conditioning device. The mixing device for the thick phase and the inspissated purification phase can be arranged in front of the conditioning device; also, the additives can be supplied directly to the conditioning device through a feeder unit.

The fluidized-bed drying system can be made as an appliance for the removal of fluids and/or solids from a mixture of particulate materials with a container that constitutes a ring-shaped processing space with a cylindrical outer contour. It has devices for the charging and discharging of the particulate material into and out of the processing space as well as a fan device for supplying a fluidization agent from underneath into the processing space, plus devices for the preparation of the fluidization agent in the direction of flow in front of the fan device, whereby, in the processing space, vertically extending walls form cells that extend in the vertical direction, of which cells one forms a discharge cell through which flows no fluidization agent or only a reduced measure of fluidization agent, from underneath, upon whose lower end the discharge device is arranged and of which another cell is provided with the charge device and constitutes a charge cell and where the cells are open at their upper end. The following is provided: above the walls there are arranged twist scoops, that are inclined or curved in the direction of flow from the charge cell to the discharge cell, whose outside diameter is no larger than the outside diameter of the walls and thus of the processing space, whereby the twist scoops are surrounded by an outer jacket, which does not protrude radially over the outer jacket of the processing space. The fluidization agent flows from underneath through the processing space, exiting upward, between the twist scoops into the transition area above. As a result of the arrangement of twist scoops above the vertical walls, it is possible to influence and support the direction of flow of the fluidization agent, in particular, superheated vapor, as well as the direction of movement of the material that is to be treated. The twist scoops are so curved or inclined that, in the free space arranged above, there is generated—preferably without any assemblies that influence the current—a rotating homogeneous fluidization agent stream, called the twist stream [current]. The centrifugal forces of this twist stream [current] move the particles, that are carried along, radially, outward, where they partly again fall down into the area of the twist scoops or again into the processing space. The direction of the twist current prevents moist particles from moving out of the charge cell directly into the discharge cells.

The currents of fluidization agent, that enter, out of the individual cells, through the twist scoop area and then into the free space of the transition area, in terms of their quantitative flow and their conditions of state, have different values that are homogenized in the twist current. A conical widening of the transition area and the provision of likewise conically widening assemblies and baffle plates, is no longer required, so that, along with the space saving due to the at least identical outer dimensioning in the axial direction, one can save considerable material in building the appliance.

It is possible to shape the area above the twist scoops cylindrically or tapering conically upward in order to provide the most compact possible outer jacket and thus to wind up with a construction that uses as little material as possible.

The cells, that are fashioned by the vertical walls, at whose upper end the twist scoops can adjoin, can extend radially up to the outer wall so that they represent a genuine subdivision and barrier in the circumferential direction. At the lower end of the walls, there can be passage openings so that the material—especially the coarse particulate materials—can also move on, underneath the walls, in the circumferential direction. The number of twist scoops essentially depends on the number of vertical walls, the arrangement of the twist scoops is not confined to the immediate association of the upper edge of the walls with the lower edge of the twist scoops.

The twist scoops can be attached to the walls or can be made together with them, something that facilitates continual conveyance both of the particulate materials and of the fluidization agents. As an alternative, one can provide twist scoops between the lower edges and a vertical interval along the upper edges of the walls which [interval] facilitates free passage from the charge cell up to a place in front of the discharge cell, but not from the discharge cell to the charge cell. The interval is used for the uncoupling of the walls from the twist scoops and for the reduction of the total weight of the appliance.

A dust arrester is integrated above the free space and the fluidization agent flows in through additional twist scoops along the underside of said dust arrester. The additional twist scoops have an orientation that is identical to that of the twist scoops and display a greater inclination or curvature in order to bring about an essentially circular current movement both of the fluidization agent, and of the dust particles, that are swept along by the fluidization agent, as well as the particulate materials in the dust arrester. In other words, there is a two-stage diversion of the current or of the particle flow through the twist scoops and the additional twist scoops as a result of which a centrifugal field is generated in the dust arrester, in which field the dust particles and the particulate materials, that are swept along, are preferably moved outward and leave the dust arrester through at least one opening in the dust arrester wall.

An embodiment of the invention provides the following: the pressure side of the twist scoops, with relation to the axial flow speed component of the fluidization agent, is inclined, along the lower edge, at an angle of up to 10°. Along their lower edges, the twist scoops can also be oriented parallel to the axial component of the current of the fluidization agent and can incline or curve only then. The correspondingly curved or inclined attitude of the twist scoops at an angle of up to 10° however is also provided and possible.

On the upper edge, the twist scoops are—on their pressure side related to the axial flow speed component—inclined at an angle of up to 35° in order to bring about a correspondingly intensive diversion both of the flow of the fluidization agent and of the particulate materials.

A superheater is arranged within the container in the invention-based appliance, whereby the inside diameter of the twist scoops corresponds to the outside diameter of the superheater. The twist scoops thus end radially inside with the superheater. The radially outer sides of the twist scoops extend up to the container wall, whereby, on the radially outer side, there can also be a gap between the lateral edges of the twist scoops and of the container wall.

On their pressure side, related to the axial flow speed component of the fluidization agent, the additional twist scoops are inclined, along the lower edge, at an angle of up to 15°, in order to bring about a stronger deflection of the flow. At their upper edge, the inclination is as much as 90° in order to deflect the axial movement almost completely into the circumferential direction. The twist and additional twist scoops preferably are made of sheet metal-like material; therefore, the angles on the pressure side correspond to the amount of the angles on the side facing away from the pressure side.

Above the additional twist scoops, there are provided return [recycling] or return twist scoops with an inclination or curvature opposite to the twist scoops and to the additional twist scoops, and the pressure side [of these return or return twist scoops], related to the axial flow speed component of the fluidization agent, inclined at the entry end at an angle of up to 90°, whereby the inclination at the exit end is inclined at an angle of up to 0°, so that, out of the essentially ring-shaped flow in the circumferential direction, there is again made a flow parallel to the axial direction. As a result, the fluidization agent is deflected in the axial direction so that there is preferably a return to the superheater and to the fan.

In an embodiment of the invention, the fluid is evacuated via a centrally arranged discharge pipe, whereby the return scoops, at their radially inner end, adjoin the discharge pipe.

The return scoops can have a doubly curved or doubly inclined shape, and the same applies to the twist scoops and the additional twist scoops.

Besides, additional devices for purification, recycling, as well as heating of the fluidization agent can be series-connected in front of the fan in order to condition the fluidization agent.

An onflow tray with throughflow openings is arranged at the lower end of the processing space. This onflow tray can have devices to influence the volume flow so that, looking in the circumferential direction, in other words, in the direction of transport of the material to be treated, one can supply differing volumes of the fluidization agent. The differing volumes of the fluidization agent, for example, can be arranged as a function of the position of the cells. The heavier the material to be treated is, that is to say, the moister the material is, the higher must be adjusted the quantity of the fluidization agent.

The cell with the charge device and the discharge cell can also be arranged next to each other whereby, to prevent an immediate transport from the charge cell to the discharge cell, there is provided a separation device. When the charge cell and the discharge cell are arranged next to each other, the material must run through the entire circumference of the essentially ring-shaped processing space.

A further development of the invention provides the following: the onflow tray is so shaped that the discharge of particles out of the processing space into the twist scoop area takes place due to bursting bubbles of the fluidized particles in accordance with the separation conditions above the twist scoops, preferably radially outward, near the container wall. In order to strengthen the eddy movement in the lower area of the processing space and along the radially outer edge of the processing space, in other words, in the area of the outer wall, to provide increased flow speed, so that the material there will be transported upward, it is provided that, on the radially outer area of the onflow tray, there is adjusted a greater opening ratio than on the radially inner area of the onflow tray, which means: more or larger passage openings are arranged in the area of the outer wall in the onflow tray than in the area of the inner wall of the processing space, in other words, in the vicinity of the superheater.

The onflow tray is made arched to prevent particle deposits in the radially inner area of the processing space. The arching here can be constant or it can be provided via a number of essentially straight sheet metal pieces that are arranged at an angle with respect to each other. As a result of the arching of the onflow tray in combination with the varied opening ratio of the onflow tray in the radial direction, there is generated a circulating fluidized-bed movement of the particles in the radial direction. The contour here is to be seen in the plane of the vertical walls so that the onflow tray, under the walls, will form an arch or an arch-shaped polygonal segment. In contrast to that, if the onflow tray is level, there is the danger of the deposit of large particles that are difficult to fluidize.

The onflow tray can have passage openings for the fluidization agent which can have different shapes. The passage openings, for example, can be made as holes, slits, or other free passage surfaces. Likewise, the passage openings can be made by gaps in the sheet metal pieces of which the onflow tray is made.

As uniform as possible a fluidization state is provided in the cells to ensure particle transport. The technical fluidization properties of the particles change as a result of the removal of fluid from charge to discharge; therefore, in the area of the charge cell, there is set a greater opening ratio than in the area of the discharge cell.

Preferably, the opening ratio decreases from the charge cell to the discharge cell, gradually or continually. The openings in the onflow tray can be arranged perpendicularly or at an angle thereto, in order to influence the movement of the material inside the processing space.

### BRIEF DESCRIPTION OF THE DRAWINGS

An exemplary embodiment of the invention will be explained in greater detail below with reference to the attached Figures.

FIG. 1 is a diagram showing an arrangement of a drying appliance.

FIG. 2 is a general view of a variant of the fluidized-bed dryer.

FIG. 3 is a partial profile side view of the appliance.

FIG. 4 is a profile view along line A-A in FIG. 3.

FIG. 5 is a profile view along line D-D in FIG. 3.

FIG. 6 is a profile view along line C-C in FIG. 3.

FIG. 7 is a profile view along line B—B in FIG. 3.

### DETAILED DESCRIPTION OF THE PREFERRED EMBODIMENT

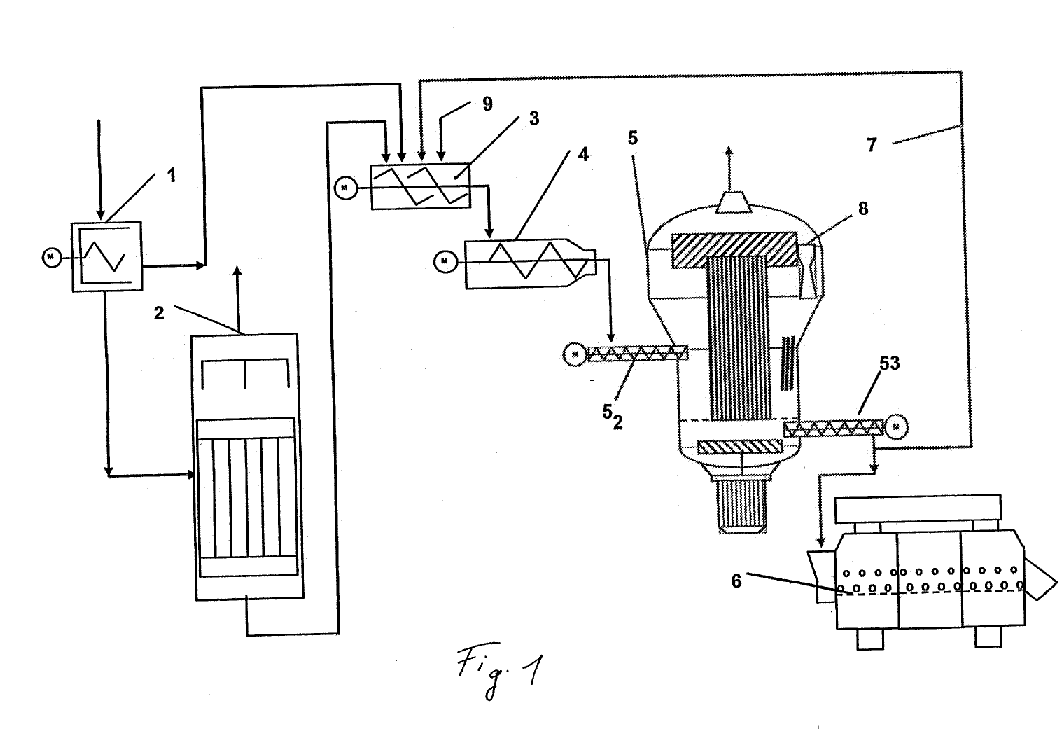

The diagram in FIG. 1 shows an appliance for drying byproducts that accrue during the processing of starch-containing and sugar-containing raw materials. The prepositioned processing steps, for example, in the area of alcohol production, are not illustrated. The byproduct, the so-called malt residuum, is obtained in a more or less liquid form and is supplied to a separating or fractionating device 1 in which the byproduct is separated into a purification phase and a thick phase. Separation in the fractionation unit 1 takes place via one or several mechanical separation devices in which a simple or multiple gravitational field is built up. Fractionation device 1 can have an arched sieve with a simple gravitational field or a decanter or separator with a multiple gravitational field.

The purification phase which is obtained in the separation device 1—which has a high liquid proportion—is piped into an evaporator 2 in which the purification phase is heated and is evaporated to a syrup. The liquid, which escapes in the form of a vapor, is deflected upward out of the evaporator 2 and the syrup, that is obtained after evaporation, is discharged downward and supplied to a mixing device 3. The syrup device is combined in the mixing device 3 with the thick phase from the separation device 1 and is mixed there to form an essentially homogeneous mixed phase. Mixing device 3 can be motor-driven, a motor drive can also possibly be omitted.

From the mixing device 3—in which the thick phase and the evaporated purification phase, in other words, the syrup, are combined—the resultant mixed phase is then conveyed into a conditioning device 4. The mixing device 3 can be immediately series-connected in front of the conditioning device 4 and can also be made as a purely passive element, for example, as a charge funnel.

In the conditioning device 4, the mixed phase is conditioned in a shaping manner, in other words, it is transformed into particles, as a result of the supply of pressure and possibly temperature. The conditioning device 4 here can be made as expander, extruder, or pelletizer. By the same token, combinations of different conditioning devices 4 can be series-connected, one behind the other, provided this is necessary or required.

From the conditioning device 4, the particles, obtained therefrom, in other words, the particulate existing mixed phase, is supplied to a fluidized-bed dryer 5, for example, via a screw conveyor 51, in which are dried the particles with a particle gap volume in the range of ε, between 0.5 and 0.92. The particles in this case fall down from above into a processing space that has flow coming at it from underneath and which is limited underneath via an onflow tray. By means of this onflow tray, which has openings for the passage of the fluidization agent, the fluidization agent, preferably superheated vapor, is fed in so that the moist particles are dried and simultaneously fluidized. The processing space inside the fluidized-bed dryer 5 here is preferably subdivided into vertical cells that are open at their upper end so that the particles, that are flung upward, can get into the nearest cell. At the lower end of the cell walls, there are provided passage openings so that there can also be material transport along the onflow tray in the circumferential direction of the essentially ring-shaped processing space.

Next to the charge cell, with the charge device 51, there is provided a discharge cell with a bottom part that has reduced onflow or no onflow at all, when viewed from underneath. The charge cell and the discharge cell are located next to each other and are extensively separated from each other in terms of flow technology, so that the charged particles must run through the essentially ring-shaped processing space, until they get into the discharge device 52 from which the dried particles of the byproduct are discharged. This can be done by an endless discharge screw 52 that is motor-driven.

From the discharge device 52, the dried and warm particles are fed to a cooling device 6 that is also made as a fluidized-bed device. The fluidization agent is not superheated hot vapor but rather preferably cool air. After adequate cooling, the finished product is discharged out of the system, for example, it is packaged and sold. A dust arrester is arranged in cooling device 6 in order to be able to separate any dust particles that might possibly have been generated during the transport to the cooling device 6.

A part of the dried and preferably not yet cooled product is fed back to the mixing device 3 via a return [recycling] line 7, to the extent that the mixed phase from the thick and phase and syrup, is too fluid in order to be able to be processed, in the conditioning device 4, to form particles with adequate stability, which stability is required so that [the particles] will not decompose in the fluidized-bed layer of the fluidized-bed dryer 5.

Within the fluidized-bed dried 5, there is arranged a dust arrester 8 that discharges existing dust particles so that almost dust-free end product can be transported out of the discharge device 2. If additional dust particles should be generated during the transport out of the fluidized-bed dryer 5 to the cooling device 6, then these particles are also separated on account of the fluidized-bed procedure inside the cooling device 6 and that results in a dust-free product.

Basically, the process, which was explained with reference to the illustration, can also be implemented without recycling of the dried particles. By the same token, additional additive substances can be added to the mixed phase in the mixing device 3, so that the property of the mixed phase can be adjusted in a specially oriented fashion, in order to perform a conditioning step in the conditioning device 4. Likewise, the desire of properties can be adjusted by means of the additives, for example, during the production of animal fodder. The additives can be supplied separately via a supply device 9 and, by the same token, the dried particles can be added via the supply device 9. The above-described process can be implemented with the pure thick phase and the modified thick phase, in other words as mixed phase.

Waste gases or exhaust vapors from the fluidized-bed dryer 5 are conveyed upward.

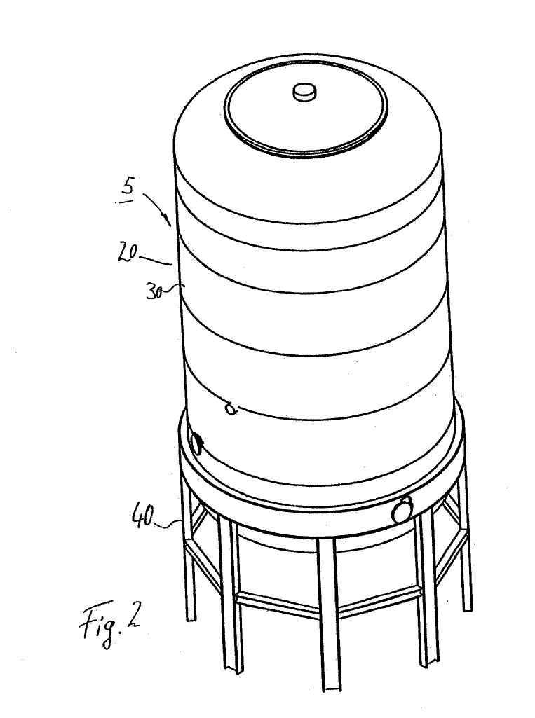

FIG. 2 shows a variant of the invention where the fluidized-bed dryer 5 has an essentially cylindrical structure. The other devices of the appliance are essentially identical so that no further illustration is needed here.

FIG. 2 is a perspective view of an appliance 5 with a container 20 that has an essentially cylindrical outer skin 30. Container 20 is positioned on a frame 40 in order to make appliance 5 accessible to maintenance also from underneath.

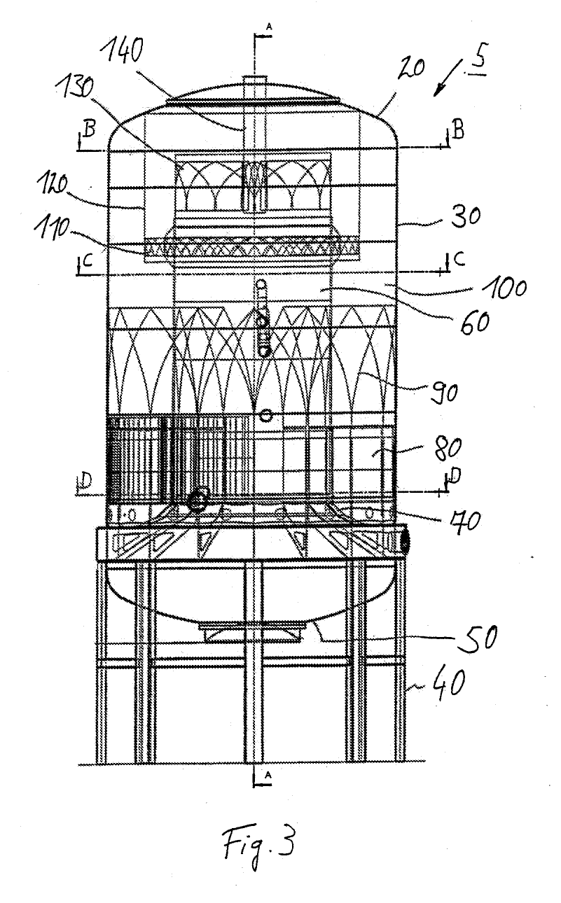

FIG. 3 shows appliance 5 with container 20 in a partially cut-away side view, where the outer skin 30 was partly removed. One can see that the outer contour of container 20 is essentially cylindrical. The geometrical structure of container 20, as well as of the components arranged therein, will be described below.

Container 20, placed on a frame 40, at its lower end has an arched bottom 50 in which is arranged a ventilator wheel, not shown, by means of which a fluidization agent, especially superheated vapor, is circulated in container 2. Inside container 20, there is arranged an essentially cylindrical superheater 60 so that the fluidization agent is fed in from underneath, into an essentially ring-shaped processing space 200, that is made between superheater 60 and outer skin 30. At its lower end, processing space 200 is limited by an onflow tray 70 that permits passage of the fluidization agent from underneath but that does not allow the treated material to fall through.

Above onflow tray 70, there are arranged vertically aligned walls 80 that extend from the outer wall of the superheater 60 up to the container wall 30 and that form cells between themselves. Walls 80 can extend all the way down to the onflow tray 70 or can form a free space between. The cells, formed by the walls 80, are open on top, so that the fluidization agent will flow through, from underneath, upward, through the cells, and will sweep along the material to be treated for the particles and possibly transport it into a subordinate cell. The cell, provided with a discharge device, not shown, now has no flow of fluidization agent through it or has only a small flow, so that material, falling from above into that cell, will get into the bottom area and can be removed via the discharge device 52, for example, a screw conveyer, out of the discharge cell 170.

Twist scoops 90 adjoin above walls 80 and these scoops can also be arranged between the walls 80 and, in terms of the vertical extent, can approximately correspond to the vertical extent of the walls 80 or they can extend beyond that, in other words, they can be longer than the walls 80. On their underside, to which faces toward walls 80, twist scoops 90 can be aligned essentially parallel to the walls 80, so that the pressure side of the twist scoops 90 will be oriented at an angle of 0° to the axial component of the flow speed of the fluidization agent. In the exemplary embodiment illustrated, twist scoops 90 are shown curved and are so oriented that the curvature points from the charge cell 150 to the discharge cell 170. For example, if the charge cell 150 and the discharge cell 170 are arranged next to each, then the curvature points away from the discharge cell 170, so that the particle and material stream must be transported over the entire circumference of container 20 and thus of the processing space 200, in order to get to the discharge cell 170.

At the upper end, the twist scoops 90 have a curvature of up to 35° with respect to the axial component of the flow speed of the fluidization agent, in order to deflect the current of the fluidization agent and that of the material into the circumferential direction. The twist scoops 90 represent the prolongation of walls 80 whereby this prolongation can be made with or without gap between the twist scoops 90 and the walls 80. The twist scoops 90 can form a singly or doubly curved surface, in other words, they can have a curvature both around the axial component and around a radial component, in order to divert the flow of the fluidization agent, and the direction of movement of the material in accordance with requirements. Instead of a curvature, there can also be provided an inclination of otherwise straight-walls twist scoops 90 for the deflection of the direction of flow.

Above twist scoops 90 there is a transition area 100, made as a free space, that is not provided with any flow-influencing assemblies, so that the flow of the fluidization agent as well as the transport of the material and the particles, swept along in the fluidization agent stream, can take place essentially unhindered. This free space 100, the so-called transition area, is ring-shaped and permits free, circular passage both of the material and of the fluidization agent in the horizontal plane.

Above the twist scoops 90 and the transition area 100, there are arranged additional twist scoops 110 that also have a singly or doubly curved surface, although with an entry angle of to 15°, related to the axial flow speed component on their pressure side. The discharge angle, with the same nomenclature, amounts up to 90° whereby the inside diameter of the scoops corresponds to the outside diameter of the superheater 60.

Above the additional twist scoops, there is made a dust arrester 120 whose outside diameter is smaller than the outside diameter of the processing space 200 and thus is smaller than the outside diameter of the container housing 30 in the area of walls 80 and the twist scoops 90. The outside diameter of the additional twist scoops corresponds to the outside diameter of the dust arrester 120. Due to the adaptation of the additional twist scoops to the twist scoops 90, we get a structure—optimized in terms of pressure loss—of appliance 5, so that the appliance as a whole can be operated with a high degree of efficiency. The outer contour 30 of container 20 here is cylindrical at least up to the level of the twist scoops 90, especially up to the level of the dust arrester 120 or the additional twist scoops 110, as a result of which one can prevent a material-intensive construction of the container 20 that is preferably shaped as pressure reservoir. The pretwist scoops generate and support—via the fluidized-bed layer present in the processing space 200—a pretwist or the twist flow as result of which the required and desired further transport from the charge cell 150 to the discharge cell 170 is supported. A centrifugal field is generated within the dust arrester 120 and in that field, the dust particles and the particulate materials, that are swept along, are moved in a manner circulating outside and are discharged through and opening.

Above the additional twist scoops 110 there are arranged recycling scoops 130, oriented against the direction of twist, which recycling scoops deflect the twist both of the fluidization agent and of the dust particles that are swept along in the fluidization agent, and are converted into a static pressure in order to supply the fluidization agent to the superheater 60. The return or recycling twist scoops 130 also have a singly or doubly curved or inclined surface with an entry angle of up to 90° related to the axial flow speed component of the fluidization agent, whereby the discharge angle, at identical nomenclature, amounts to as much as 10°. The inside diameter of the scoops corresponds to the outside diameter of a discharge pipe 140, while the outside diameter of the scoops corresponds to the inside diameter of the superheater 60.

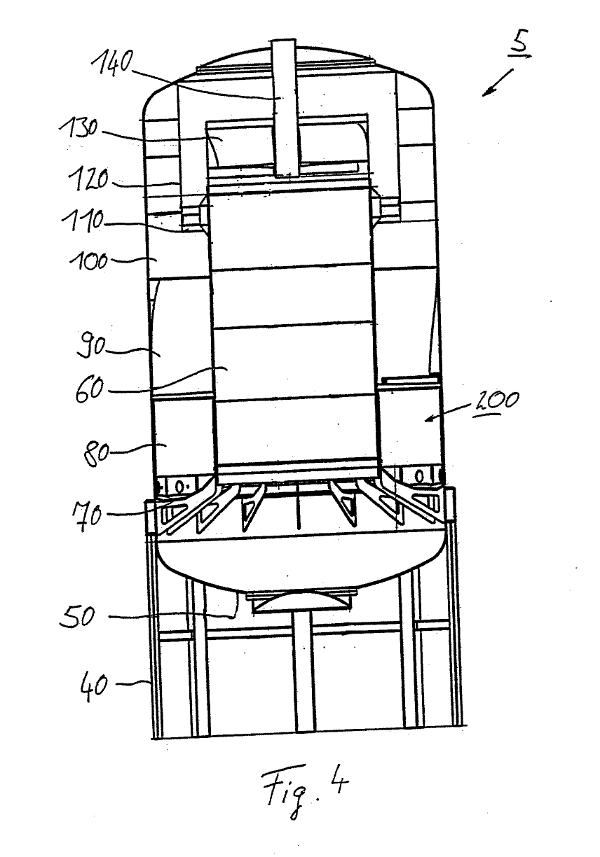

FIG. 4 shows a profile view of appliance 5, revealing the structure of the onflow tray 70 and the walls 80 that adjoin above. Between walls 80 and the curved or inclined twist scoops 90, there is a free space; basically, the twist scoops 90 can also adjoin directly upon walls 80.

The ring-shaped transition area 100, above the twist scoops 90, can be recognized here, as can the centrally arranged superheater 60, that extends almost over the entire length of container 20, so that, above the onflow tray 70, up to the lower edge of the twist scoops 90, there will be a ring-shaped processing space 200. Dust arrester 120, with the additional twist scoops 110, arranged at the lower end, and the recycling scoops 130, for the deflection of the circulating current into an axially directed current, can be recognized as can the outside dimension of the recycling scoops 130, which corresponds to the outside diameter of the superheater 60, and the arrangement of the recycling scoops 130 around the discharge pipe 140, that is arranged centrally in container 20.

The twist scoops replace the hitherto customary, upwardly widening cone and deflect the flow, so that larger particles of the material can be deflected radially outward and can be braked on the container wall and, due to the force of gravity, can fall down again, so that they can be exposed to further treatment by the fluidization agent. The transport of the particulate materials from the charge cell 150 to the discharge cell 170 takes place along the onflow tray 70 in the circumferential direction through the cutouts provided in the walls 80 and arranged at the bottom. Furthermore, the material to be dried is transported above the twist scoops 90 with the help of the twist current that is generated by the twist scoops 90 so that no additional assemblies are required.

The additional twist scoops 110 represent a set of scoops that are optimized in terms of pressure loss, which set of scoops deflects the fluidization agent into a strengthened twist current in order to be able, via a side cyclone, to separate any as yet present material or dust particles. The recycling scoops 130 essentially have an axial structure and extend radially, outward from the discharge pipe 140. As a result, the twist is reduced and converted into static pressure, something that results in easier recycling of the fluidization agent through the superheater 60. The outer container wall 30 can also be adapted to the contour of the dust arrester 120 as a result of which one can further reduce the required structural space above the additional twist scoops 110.

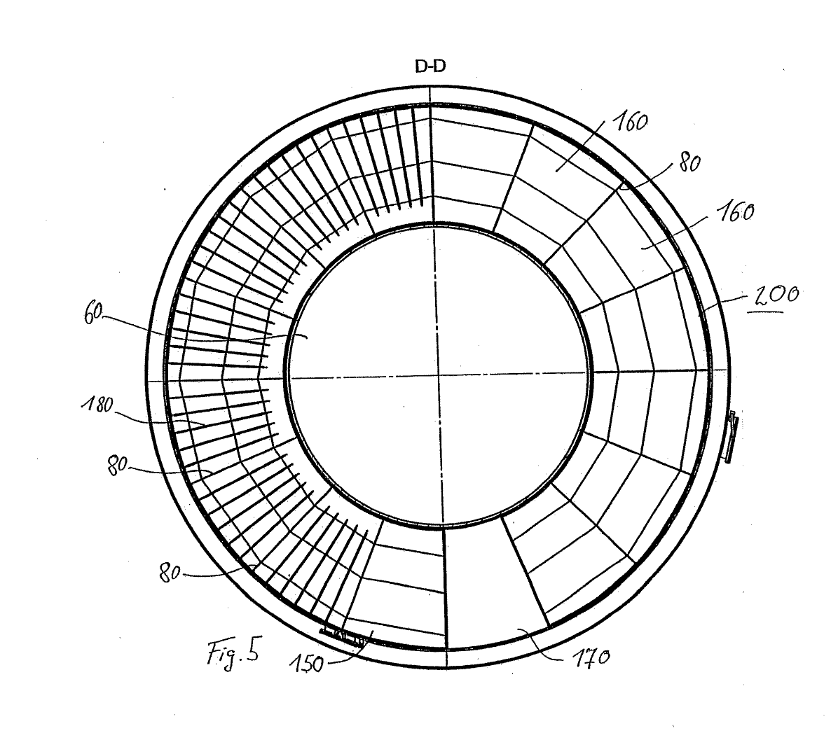

FIG. 5 represents a horizontal profile along line D-D in FIG. 3. At the lower end, we can see the charge cell 150 with a charge device, not shown, for example, a screw conveyer device, that is arranged immediately next to the discharge cell 170, whereby the charge cell 150 and the discharge cell 170 are so separated from each other in terms of flow technology that one can prevent the immediate transition of the material from the charge cell 150 into the discharge cell 170. Starting with the charge cell 150, we find adjoining a plurality of processing cells 160 that are separated from each other by partitions 80. Partitions 80 here can adjoin all the way directly to the container wall 30 or can be suspended at a certain interval thereof within the ring-shaped processing space 200, that, on the underside, is limited by the onflow tray 70 and on a topside, by the underside of the twist scoops 90. Inside the processing cells 160, there can be intermediate heating walls 180 in order to heat the product that is to be processed.

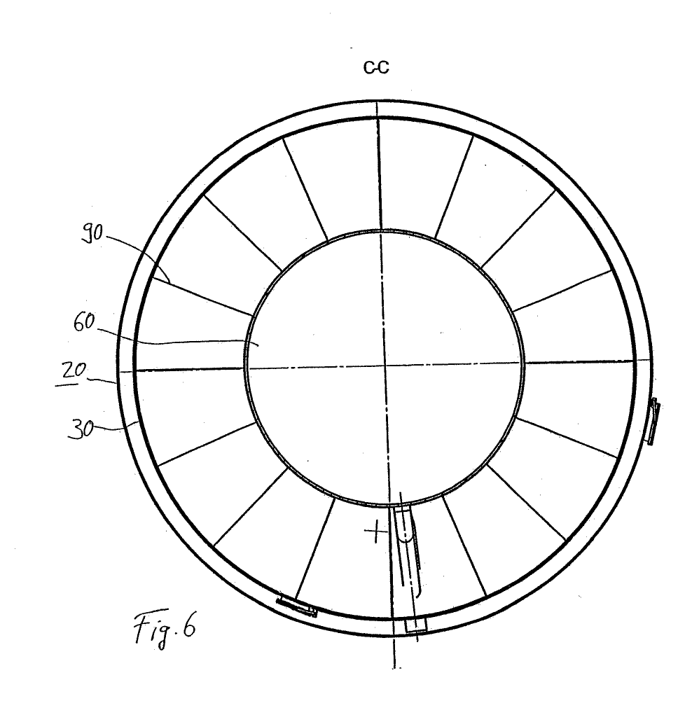

FIG. 6 shows a horizontal profile along line C-C in FIG. 3; it indicates the central arrangement of the superheater 60 and the twist scoops 90 that are arranged in a ring-shaped pattern around [the superheater]. Twist scoops 90 form the prolongation of the vertical, radially extending walls 80 and extend from superheater 60 all the way to the outer wall 30 of container 20. Twist scoops 90, just as walls 80, are essentially aligned radially and can display a single or double inclination or curvature, in order to deflect the mostly axial current or movement of the material to be dried on account of the flow of the fluidization agent, which is directed from down to upward, and to provide it with a twist.

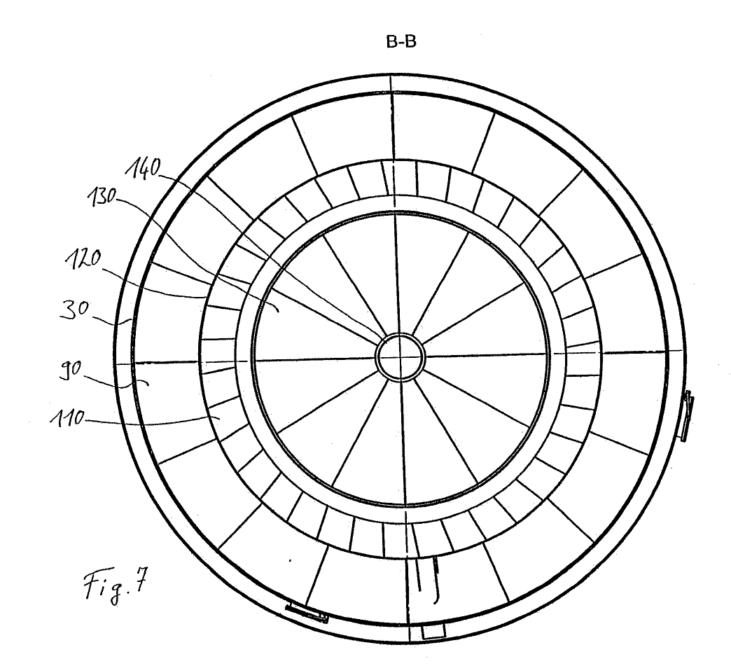

FIG. 7 shows a horizontal profile along line B-B in FIG. 3, indicating the twist scoops 90, the additional twist scoops 110, as well as the essentially cylindrical housing of dust arrester 120. The additional twist scoops 110 also extend essentially radially outward and, with their inside, rest against the housing of superheater 60; radially outward, they extend all the way to the outer wall of the dust arrester 120 and, on account of their inclination or curvature, they cause a deflection that is increased with respect to the twist scoops 90 and they thus bring about an increase in the twist. Dust particles can be evacuated out of the dust arrester 120 for example, via a side cyclone arranged outside appliance 5; it is also possible to convey these dust particles into the discharge chamber 170.

Above additional twist scoops 110, there are provided return or return twists scoops 130 that essentially act in an axial direction and that convert the flow of the fluidization agent, oriented in a circumferential direction, into a static pressure and that supply the fluidization agent to the superheater 60 for preparation or heating. Centrally arranged is a discharge pipe 140 through which the fluidization agent can be evacuated. Recycling scoops 130 extend radially outward, from the discharge pipe 140, up to the circumference of superheater 60. Additional preparation devices for the fluidization agent can be provided in order to condition said agent. In particular, one must provide purification devices so that the fan or ventilator wheel will not be damaged by the impacting dust particles or the like.

Instead of the known solution involving the conical widening of the container above the processing chamber or the cells—as known in the state of the art—it is possible, with the help of the invention-based solution, to provide a cylindrical structure for the container 20. That results in significant material savings, in particular, for a container 20 that is to be made as pressure reservoir, without the drying output being degraded when the appliance is used as evaporation dryer. The fan is so designed here that there will be a fluidization of the material which is to be treated, especially the material that is to be dried, so that the materials or particles, which are to be dried, are transported from the charge cell 150 to the discharge cell 170.

Instead of the sixteen cells or chambers, shown in the Figures, with the first charge cell 150, fourteen processing cells 160, and the last discharge cell 170, one can also provide deviating numbers of cells. A circulating flow control offers the advantage that the particles, in the fluidization agent, can be separated in an optimum fashion via the additional twist scoops 110 and the dust arrester 120. The circulation of the fluidization agent in one direction also facilitates the recycling and conversion of the twist impulse into a static pressure on account of the curvature or inclination of the recycling scoops 130 that display an opposite orientation in relation to the curvature or inclination of the twist or additional twist scoops 90, 110.

1. Process for drying byproducts from the processing of starch-containing and sugar-containing raw materials, especially after their fermentation and distillation, where the byproduct is fractionated during a purification phase with a high liquid proportion and a thick phase, characterized in that the thick phase is formed during a conditioning process into particles and that these particles are dried in a fluidized-bed drying system with a relative gap volume, in the fluidized-bed layer, in the range of between 0.5 and 0.92.

2. Process according to claim 1, characterized in that the fractionation of the byproduct into a purification phase and into a thick phase is performed in a simple or multiple gravitational field.

3. Process according to claim 1, characterized in that the purification phase is evaporated into a syrup and that syrup is supplied to the thick phase to form a mixed phase.

4. Process according to claim 1, characterized in that the dry particles are cooled in a fluidized-bed apparatus.

5. Process according to claim 1, characterized in that the thick phase is adjusted at a dry substance content of between 30% and 60%, especially 40%.

6. Process according to claim 1, characterized in that the thick phase is conditioned in an expander, extruder, and/or pelletizer.

7. Process according to claim 1, characterized in that the conditioning of the thick phase takes place into fluidizable individual particles.

8. Process according to claim 1, characterized in that additives are added to the thick phase.

9. Process according to claim 8, characterized in that one adds additives with a moisture content that is less than the moisture content of the thick phase.

10. Process according to claim 8, characterized in that a part of the dried particles is returned [recycled] through the thick phase as additive substance.

11. Process according to claim 8, characterized in that the additive substances are added to the thick phase in a mixture or separately in an appliance for the implementation of the conditioning procedure.

12. Appliance for drying byproducts from the processing of starch-containing and sugar-containing raw materials, in particular, after fermentation and distillation, with a mechanical separation device, for the separation of the byproduct into a purification phase with a high fluid proportion and a thick phase, characterized in that a shaping conditioning device (4) for the thick phase is series-connected after the separation device (1), which separation device shapes the thick phase into particles, and that a fluidized-bed drying system (5) is series-connected after the conditioning device (4), in which system the particles are dried.

13. Appliance according to claim 12, characterized in that there is provided a concentration [evaporation] device (12) to remove the fluid from the purification phase plus a feeder device [to convey] the inspissated [concentrated] purification phase to the thick phase.

14. Appliance according to claim 13, characterized in that a cooling device (6) is series-connected after the fluidized-bed drying unit (5).

15. Appliance according to claim 14, characterized in that a cooling device (6) is a fluidized-bed apparatus.

16. Device according to claim 12, characterized in that the separation device (1) is made as a simple or multiple gravitational field.

17. Device according to claim 12, characterized in that the conditioning device (4) is made as expander, extruder, and/or pelletizer.

18. Appliance according to claim 13, characterized in that there is provided a mixing device (3) for the thick phase and for the evaporated purification phase.

19. Appliance according to claim 12, characterized in that there is provided a feeder device (9) for additives to the thick phase.

20. Appliance according to claim 12, characterized in that there is provided a return [recycling] device (7) for a partial stream of the dried particles to the mixing phase.
